(19) United States
(12) Patent Application Publication
(10) Pub. No.: US 2021/0182742 A1
(43) Pub. Date: Jun. 17, 2021

(54) AUTOMATED VALET PARKING SYSTEM

(71) Applicant: Toyota Jidosha Kabushiki Kaisha, Toyota-shi Aichi-ken (JP)

(72) Inventor: Ryuji Okamura, Gotemba-shi (JP)

(21) Appl. No.: 17/115,062

(22) Filed: Dec. 8, 2020

(30) Foreign Application Priority Data
Dec. 13, 2019 (JP) 2019-225484

(51) Int. Cl. G06Q 10/02; G06Q 30/06; G06Q 30/02; G06Q 50/30; G07B 15/02; G08G 1/14

(52) U.S. Cl. CPC G06Q 10/02; G06Q 30/0645; G08G 1/146; G06Q 50/30; G07B 15/02; G06Q 30/0207

(57) ABSTRACT

A management server executes parking request processing to process a parking request information when it receives the parking request information from a primary user terminal that includes a condition for parking of a vehicle, a condition for lease-offer indicating a condition to provide a lease of the vehicle. In the parking request processing, the management server determines whether a parking facility has a parking space that satisfies the condition for parking. If the management server determines that parking facility has the parking space, it transmits a parking reservation information to the primary user terminal and transmits the condition for lease-offer to a secondary user terminal.

### CROSS-REFERENCE TO RELATED APPLICATION

The present application claims priority under 35 U.S.C. § 119 to Japanese Patent Application No. 2019-225484, filed Dec. 13, 2019. The contents of this application are incorporated herein by reference in their entirety.

### TECHNICAL FIELD

The present disclosure relates to a system for managing an AVP (Automated Valet Parking) in a parking facility.

### BACKGROUND

JP2019-67200A disclose an AVP system. The conventional AVP system comprises a parking facility and a management device for managing the AVP in the parking facility. At a loading of a vehicle, the management device controls an automated travel of the vehicle from a predetermined location on an outside of the parking facility to a predetermined parking space located inside the parking facility. At an unloading of the vehicle, the management device controls the automated travel from the predetermined parking space to the predetermined location.

### SUMMARY

In the conventional AVP system, an appropriate space to park the vehicle is selected from a plurality of candidates for parking. That is, a plurality of spaces for the AVP are prepared. However, when number of the spaces for the AVP is limited and all of them are occupied by a plurality of the vehicle for a long time, an opportunity of new parking is lost.

It is an object of the present disclosure to provide a technique capable of eliminating a long-term occupation of the space for the AVP.

A first aspect is an AVP system and has the following features.

The AVP system is configured to manage an automated valet parking of a vehicle.

The AVP system includes a processing device, a primary user terminal, a secondary user terminal, and a communication device.

The processing device is configured to execute travel control processing in a parking facility of the vehicle.

The primary user terminal is a terminal of a primary user of the vehicle.

The secondary user terminal is a terminal of a secondary user using a lease vehicle.

The communication device is configured to perform a communication between the primary user terminal and the processing device, and to perform the communication between the secondary user terminal and the processing device.

The processing device is further configured to, when receiving from the primary user a parking request information, execute parking request processing to process the parking request information. The parking request information includes a condition for parking of the vehicle and a condition for lease-offer indicating a condition to provide a lease of the vehicle.

In the parking request processing, the processing device is configured to:

determine whether or not the parking facility has a parking space that satisfies the condition for parking; and

if it is determined that the parking facility has the parking space, transmit a parking reservation information to the primary user terminal and transmit the condition for lease-offer to the secondary user terminal.

The second aspect further has the following features in the first aspect.

The processing device is further configured to, when receiving from the secondary user terminal a lease request information that includes a condition for lease-use indicating a condition to utilize the lease vehicle, execute lease request processing to process the lease request information.

In the lease request processing, the processing device is configured to:

determine whether or not the condition for parking and the condition for lease-offer agree on the condition for lease-use; and

if it is determined that the condition for parking and the condition for lease-offer agree on the condition for lease-use, transmit a lease reserve information to the secondary user terminal.

The third aspect further has the following features in the first aspect.

The processing device is further configured to parking fee checkout processing to settle a parking fee of the primary user.

In the parking fee checkout processing, the processing device is configured to discount from the parking fee an amount in accordance with a lease fee of the vehicle, if the vehicle is provided to the lease during loading of the vehicle to the parking facility based on the parking request information.

The fourth aspect has the following features in the first aspect.

The parking facility includes a first and a second parking facilities.

The secondary user terminal includes a first and a second user terminals.

The processing device is further configured to execute, when receiving from the first user terminal incidental parking request information while the vehicle has been unloaded from the first parking and being leased, incidental parking request processing to process the incidental parking request information. The incidental parking request information includes incidental condition for parking of the vehicle and a condition for sublease-offer indicating a condition to provide a sublease of the vehicle.

In the incidental parking request processing, the processing device is configured to:

determine whether or not the second parking has incidental parking space that satisfies the incidental condition for parking; and

if it is determined that the second parking has the incidental parking space, transmit a parking reservation information to the first user terminal and transmit the condition for sublease-offer to the second user terminal.

The fifth aspect further has the following features in the fourth aspect.

The processing device is further configured to, when receiving from the second user terminal incidental lease request information including incidental condition for lease-use indicating a condition to utilize the lease vehicle, execute incidental lease request processing to process the incidental lease request information.

In the incidental lease request processing, the processing device is further configured to:

determine whether or not the incidental condition for parking and the condition for sublease-offer agree on the incidental condition for lease-use; and
if it is determined that the incidental condition for parking and the condition for sublease-offer agree on the incidental condition for lease-use, transmit incidental lease reserve information to the second user terminal.

The sixth aspect further has the following features in the fourth aspect.

The processing device is further configured to lease fee checkout processing to settle lease fee of the secondary user.

In the lease fee checkout processing, the processing device is configured to discount from the lease fee an amount in accordance with a sublease fee of the vehicle, if the vehicle is provided to the sublease during the loading of the vehicle to the second parking based on the incidental parking request information.

According to the first aspect, the parking request processing is executed. In the parking request processing, if it is determined that the parking facility has the parking space, the parking reservation information is transmitted to primary user terminal. If the condition for lease-offer is included in the parking request information, this condition for lease-offer is transmitted to the secondary user terminal. Therefore, it is possible to urge the secondary user to use the lease of the vehicle. Then, if the secondary user utilizes the vehicle, the space for AVP occupied by this vehicle will be empty. Therefore, it is possible to solve the occupation of the space for AVP for a long time.

According to the second aspect, the lease request processing is executed. In the lease request processing, the lease reserve information is transmitted to the secondary user terminal when the condition for parking and the condition for lease-offer agree on the condition for lease-use. This allows the primary user who leases the vehicle and the secondary user who utilizes the lease vehicle to be matched effectively.

According to the third aspect, the parking fee checkout processing is executed. In the parking fee checkout processing, when the vehicle is leased, the amount in accordance with the lease fee is discounted from the parking fee. Therefore, it is possible for the primary user to obtain a merit in the parking fee when the vehicle is leased.

According to the fourth aspect, the incidental parking request processing is executed. In the incidental parking request processing, if the second parking is determined to have the parking space, the incidental parking reservation information is transmitted to the first user terminal. If the condition for sublease-offer is included in the incidental parking request information, this condition is transmitted to the second user terminal. Therefore, it is possible to obtain the same effect as that according to the first aspect.

According to the fifth aspect, the incidental lease request processing is executed. In the incidental lease request processing, the lease reserve information is transmitted to the second user terminal when the incidental condition for parking and the condition for sublease-offer agree on the incidental condition for lease-use. This allows the secondary user who provides the sublease of the vehicle and incidental secondary user who utilizes the lease vehicle to be matched effectively.

According to the sixth aspect, the lease fee checkout processing is executed. In the lease fee checkout processing, when the vehicle is subleased, the amount according to the sublease fee is discounted from the lease fee. Therefore, it is possible for the secondary user to obtain a merit in the lease fee when the vehicle is subleased.

### BRIEF DESCRIPTION OF DRAWINGS

FIG. 1 is a block diagram for explaining a configuration example of an AVP system according to embodiments of the present disclosure;

FIG. 2 is a diagram for explaining an outline of parking request processing according to a first embodiment of the present disclosure;

FIG. 3 is a flow chart showing a flow of the parking request processing according to the first embodiment;

FIG. 4 is a diagram for explaining an outline of loading processing of the vehicle according to the first embodiment;

FIG. 5 is a flow chart showing a flow of the loading processing of the vehicle according to the first embodiment;

FIG. 6 is a diagram for explaining an outline of unloading processing of the vehicle according to the first embodiment;

FIG. 7 is a flow chart showing a flow of the unloading processing of the vehicle according to the first embodiment;

FIG. 8 is a diagram for explaining an outline of lease request processing according to the first embodiment;

FIG. 9 is a flow chart showing a flow of the lease request processing according to the first embodiment;

FIG. 10 is a diagram for explaining an outline of lending processing of a lease vehicle according to the first embodiment;

FIG. 11 is a flow chart showing a flow of lending processing of the lease vehicle according to the first embodiment;

FIG. 12 is a diagram for explaining an outline of returning processing of the lease vehicle according to the first embodiment;

FIG. 13 is a flow chart showing a flow of the returning processing of the lease vehicle according to the first embodiment;

FIG. 14 is a diagram for explaining a first example of parking fee checkout processing according to the first embodiment;

FIG. 15 is a diagram for explaining a second example of the parking fee checkout processing according to the first embodiment;

FIG. 16 is a diagram for explaining assumptions of a AVP system according to a second embodiment;

FIG. 17 is a diagram for explaining an outline of parking request processing according to the second embodiment;

FIG. 18 is a flow chart showing a flow of the parking request processing according to the second embodiment;

FIG. 19 is a diagram for explaining an outline of lease request processing according to the second embodiment;

FIG. 20 is a flow chart showing a flow of the lease request processing according to the second embodiment; and

FIG. 21 is a diagram illustrating an example of lease fee checkout processing according to the second embodiment.

### DETAILED DESCRIPTION

### First Embodiment

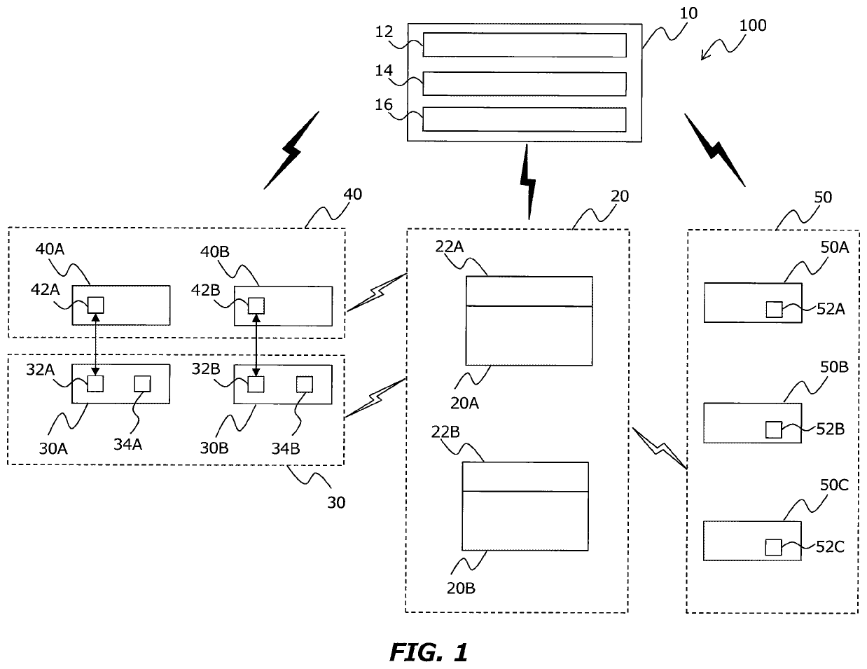

A first embodiment of the present disclosure will be described with reference to FIG. 1 to FIG. 15.

### 1. Configuration Example of AVP System

FIG. 1 is a diagram for explaining a configuration example of an AVP system according to the first embodiment. An AVP system 100 shown in FIG. 1 is a system that manages the AVP of a vehicle 30 in a parking facility 20. The AVP system 100 includes a management server 10, the parking facility 20, a primary user terminal 40 and a secondary user terminal 50.

The management server 10 manages an entire of an APV service. The management server 10 includes a processor 12, a memory device 14, and a communication device 16. The processor 12 executes various information processing by executing a computer program. The various information processing includes parking request processing, lease request processing, lease notice processing, parking fee checkout processing, and lease fee checkout processing. Details of these processing will be described later. The memory device 14 contains various information. The communication device 16 performs wireless communication over a network (i.e., internet) with the parking facility 20, the vehicle 30, the primary user terminal 40 and the secondary user terminal 50.

The parking facility 20 is a parking facility with an equipment for the AVP. Examples of the equipment for the AVP includes a gate, a sensors for detecting a vehicle, a camera for monitoring conditions in the parking facility 20, and an authentication device installed on a platform area of the vehicle. The parking facility 20 includes at least one parking facility.

In the example shown in FIG. 1, parking facilities 20A and 20B are included in the AVP system 100. The parking facility 20A includes a control center 22A. The control center 22A includes a processor, a memory device, and a communication device. The processor executes various information processing by executing a computer program. The various information processing includes loading and unloading processing of the vehicle. Details of these processing will be described later. The memory device contains the various information. The communication device performs wireless communication with the vehicle 30 (i.e., communication devices 32A and 32B) over a network. The communication device performs wireless communication with the primary user terminal 40 (i.e., communication devices 42A and 42B) and the secondary user terminal 50 (i.e., communication devices 52A and 52B) via an authentication device.

Similar to the parking facility 20A, the parking facility 20B contains a control center 22B. The function of the control center 22B is the same as that of the control center 22A.

The control centers 22A and 22B are managed under a supervision of the management server 10. However, when number of the parking facility 20 is one (e.g., when only one parking facility 20A is included in the AVP system 100), the control center 22A may be provided with the function of the management server 10. In this case, the processor of the control center 22A executes the various information processing (i.e., the parking request processing, the lease request processing, and the parking fee checkout processing) that is executed by the processor of the management server 10. The communication device of the control center 22A performs wireless communication with the primary user terminal 40 and the secondary user terminal 50 via the authentication device and the network.

If only one parking facility 20A is included in the AVP system 100, the function of the control center 22A may be aggregated in the management server 10. In this case, the processor 12 performs various information processing (i.e., the loading and unloading processing) that is executed by the processor of the control center 22A. The communication device 16 performs wireless communication with the primary user terminal 40 and the secondary user terminal 50 via at least one of the network and the authentication device.

As described above, if there is only one parking facility 20, the management server 10 or the control center (e.g., the control center 22A) acts as a “processing device” of the AVP system 100. If more than one parking facility 20 is present, the management server 10 and the control center (e.g., the control centers 22A and 22B) function as the “processing device”.

The primary user terminal 40 is a terminal carried by a primary user of the vehicle 30. Examples of the primary user include a personal owner, a corporate owner, a rental-car vendor, and a car-sharing vendor of the vehicle 30. When the primary user is the personal owner of the vehicle 30, examples of the primary user terminal 40 include a smartphone and a tablet, etc. owned by the personal owner. When the primary user is the rental-car vendor or the like, examples of the primary user terminal 40 include a smartphone, a tablet, and the like lent from the rental-car vendor or the like. Note that an application software for the AVP is installed on the primary user terminal 40.

In the example shown in FIG. 1, primary user terminals 40A and 40B are included in the AVP system 100. The primary user terminal 40A contains a communication device 42A. The communication device 42A performs wireless communication with the management server 10 via the network. The communication device 42A also has proximity wireless communication functions such as Near Field Communication, such as Wi-Fi, Bluetooth (registered trademark), or FeliCa (registered trademark), and NFC. These wireless communications are performed between the communication device 32A and 42A and are utilized for an authentication between the primary user terminal 40A and the vehicle 30A. These wireless communication are also performed between the authentication device of the parking facility 20 and the communication device 42A and are utilized for the authentication between the authentication device and the primary user terminal 40A.

Similar to the primary user terminal 40A, the primary user terminal 40B contains a communication device 42B. The function of communication device 42B is the same as that of communication device 42A. That is, the communication device 42B performs wireless communication with the management server 10 via the network. The communication device 42B performs the authentication with the vehicle 30B by the Near Field Communication or the proximity wireless communication. The communication device 42B also performs the authentication with the authentication device of the parking facility 20 by the Near Field Communication or the proximity wireless communication.

The secondary user terminal 50 is a terminal carried by a secondary user using a lease vehicle. Examples of the secondary user include an individual, a corporation, the rental-car vendor, and the car-sharing vendor. When the secondary user is the individual, examples of the secondary user terminal 50 include a smartphone, a tablet, or the like owned by the individual. When the secondary user is the rental-car vendor or the like, examples of the secondary user terminal 50 include a smartphone, a tablet, or the like owned by the rental-car vendor or the like. Note that, as with the primary user terminal 40, the application software for the AVP is installed on the secondary user terminal 50.

In the example shown in FIG. 1, secondary user terminals 50A, 50B and 50C are included in AVP system 100. The secondary user terminal 50A contains a communication device 52A. The secondary user terminal 50B contains a communication device 52B. The secondary user terminal 50C contains a communication device 52C. The function of the communication devices 52A to 52C are the same as that of the communication device 42A. That is, the communication devices 52A to 52C perform wireless communication with the management server 10 via the network. The communication devices 52A to 52C perform the authentication with the lease vehicle by the Near Field Communication or the proximity wireless communication. The communication devices 52A to 52C also perform the authentication with the authentication device of the parking facility 20 by the Near Field Communication or the proximity wireless communication.

### 2. Parking Request Processing

### 2-1. Outline

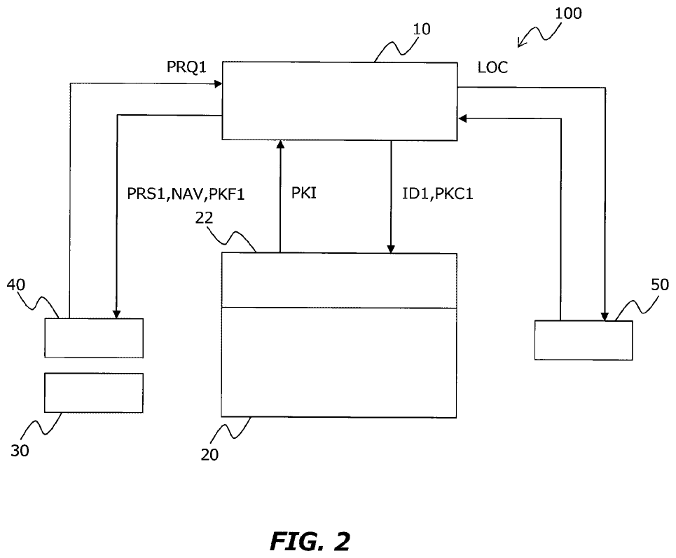

The management server 10 (the processor 12) executes the parking request processing. FIG. 2 is a diagram for explaining an outline of the parking request processing according to the first embodiment. The parking request processing is initiated when the management server 10 receives a parking request information PRQ1 from the primary user terminal 40. The parking request information PRQ1 is stored in the management server 10 (the memory device 14). The parking request information PRQ1 includes the identification ID1, a condition for parking PKC1 and a condition for lease-offer LOC.

The identification ID1 contains ID data of the primary user who carries the primary user terminal 40. The ID data of the primary user is registered by the management server 10 (the memory device 14) at an initial use of the AVP service. The registered ID data of the primary user is utilized for the authentication in a second and subsequent uses of the AVP service.

The identification ID1 also contains ID data of the vehicle 30. The ID data of the vehicle 30 is obtained from the vehicle 30 during the authentication between the primary user terminal 40 and the vehicle 30. The ID data of the vehicle 30 includes basic data (e.g., a body number and an equipment) and additional data (e.g., remaining fuels, remaining battery, and navigable distances). The basic data is registered by the management server 10 at the initial use of the AVP service. The registered basic data is utilized for the authentication of a second and subsequent uses of the AVP service. The additional data may be latest data when the parking request information PRQ1 is transmitted.

The condition for parking PKC1 includes a desired location of the parking facility 20, a desired rental date and desired rental timezone (e.g., loading time and unloading time). The desired location is selected by entering facility names (e.g., a commercial facility, an accommodation and an airport) to be used by the primary user. The desired location may be selected by a direct entry of the location of the parking facility.

The condition for lease-offer LOC is a condition to provide a lease of the vehicle 30. The condition for lease-offer LOC is optionally set by the primary user. If the condition for lease-offer LOC is set, the vehicle 30 is available as the lease vehicle. Setting of the condition for lease-offer LOC may be executed at the initial use of the AVP service, or may be executed each time the AVP service is used. The condition for lease-offer LOC contains data indicating what the primary user wants the secondary user to do. Examples of the desired items include a return of the vehicle 30 after refueling or charge, prohibition of use of a space for baggage, and prohibition of smoking in a space for ride.

The management server 10 periodically receives the parking information PKI from the parking facility 20. The parking information PKI includes data on a usage status of parking spaces in the parking facility 20. In the parking request processing, data relating to this usage state is referenced, and the parking facility 20 that matches the condition for parking PKC1 is selected. In the parking request processing, a parking space to be assigned to the vehicle 30 may be determined when the parking facility 20 is selected.

In the parking request processing, if the parking facility 20 is selected, the identification ID1 and the condition for parking PKC1 are transmitted to a control center of this parking facility 20. In the parking request processing, this condition for lease-offer LOC is also transmitted to the secondary user terminal 50 if the condition for lease-offer LOC is set. That is, when the parking facility 20 is selected, the management server 10 separates the parking request information PRQ1 and transmits appropriate information to the control center of the parking facility 20 and the secondary user terminal 50, respectively.

A timing at which the condition for lease-offer LOC is transmitted may be a timing when the parking facility 20 is selected, or may be a timing later than that. For example, the condition for lease-offer LOC may be transmitted to the secondary user terminal 50 when the management server 10 receives a lease request information LRQ from the secondary user terminal 50.

In the parking request processing, a parking reservation information PRS1 is also transmitted to the primary user terminal 40 if the parking facility 20 is selected. The parking reservation information PRS1 contains the selected parking facility 20, scheduled rental date and scheduled rental timezone (loading time and unloading time). In the parking request processing, parking fee information PKF1 may be transmitted to the primary user terminal 40 along with the parking reservation information PRS1. The parking fee data PKF1 is an estimated amount of a parking fee PF calculated based on the condition for parking PKC1. If the condition for lease-offer LOC is set, an acknowledgement may be transmitted to the primary user terminal 40 along with the parking reservation information PRS1.

### 2-2. Processing Flow

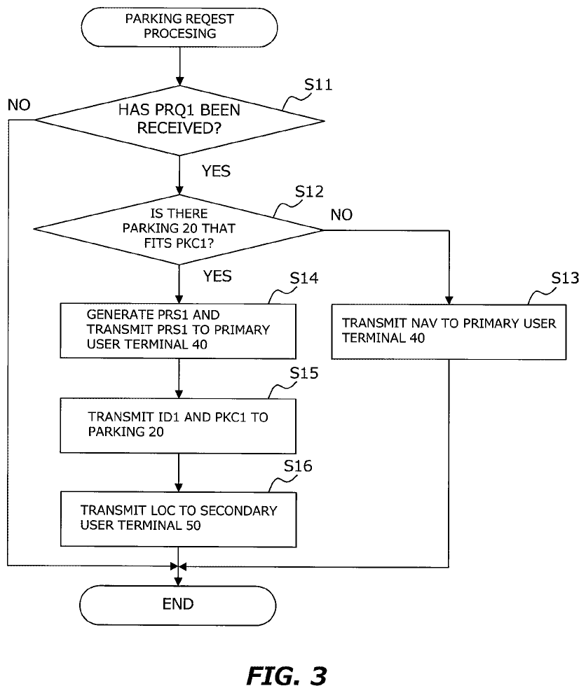

FIG. 3 is a flow chart showing a flow of the parking request processing relating to the first embodiment. The routine shown in FIG. 3 is executed at a predetermined iteration cycle.

In the routine shown in FIG. 3, first, the management server 10 determines whether or not it has received the parking request information PRQ1 (step S11). If the primary user wants to use the AVP service, the primary user launches the application software for the AVP and enters the parking request information PRQ1. Thus, the parking request information PRQ1 is transmitted from the primary user terminal 40 to the management server 10. If the determination result of the step S11 is negative, the management server 10 ends the processing of this routine.

If the determination result of the step S11 is positive, the management server 10 determines whether or not there is the parking facility 20 that matches the condition for parking PKC1 (step S12). In the processing or the step S12, the parking information PKI is referenced to search for the parking facility 20 that matches the condition for parking PKC1. If the determination result of the step S12 is negative, the management server 10 transmits an unavailable information NAV to the primary user terminal 40 (step S13).

If the determination result of the step S12 is positive, the management server 10 transmits the parking reservation information PRS1 to the primary user terminal 40 (step S14). The management server 10 also transmits the identification ID1 and the condition for parking PKC1 to the parking facility 20 that matches the condition for the parking PKC1 (step S15). If the condition for lease-offer LOC is included in the parking request information PRQ1, the management server 10 further transmits the condition for lease-offer LOC to the secondary user terminal 50 (step S16).

### 3. Loading and Unloading Processing of Vehicle

### 3-1. Outline of Loading Processing

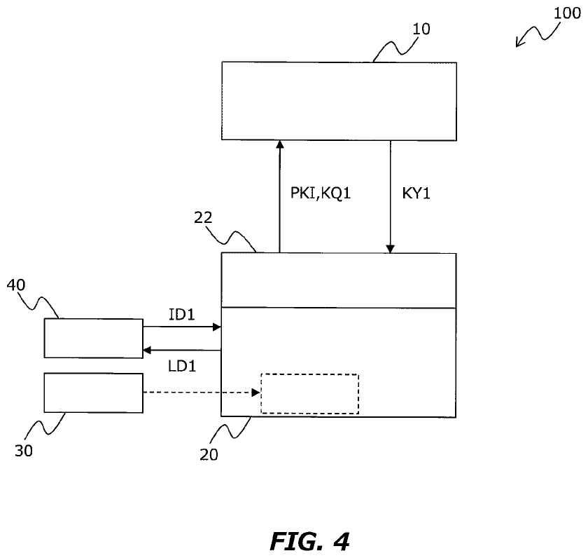

The parking facility 20 (the control center 22A or 22B) performs loading processing of the vehicle. FIG. 4 is a diagram for explaining an outline of the loading processing according to the first embodiment. The loading processing is initiated when the authentication device located near the platform area of the parking facility 20 receives the identification ID1 from the primary user terminal 40. The identification ID1 is transmitted from the management server 10 to the parking facility 20 when the parking request processing based on the parking request information PRQ1 is executed in the management server 10. In the loading processing, the identification ID1 received from the primary user terminal 40 is matched with the identification ID1 transmitted to the parking facility 20 via the management server 10.

In the loading processing, if these identifications ID1 are matched with each other, a key request KQ1 is transmitted to the management server 10. The key request KQ1 is information on an operation authority key KY1 of the vehicle 30. When the operation authority key KY1 is transmitted from the management server 10 in response to the key request KQ1 to the parking facility 20, the operation authority of the vehicle 30 is transferred from the primary user to the parking facility 20. This enables the AVP of the vehicle 30 in the parking facility 20.

In the loading processing, a communication is performed between the parking facility 20 and an AVP kit 34 (see FIG. 1) mounted on the vehicle 30. The AVP kit 34 is a controller to control a travel of the vehicle 30 in the parking facility 20. The AVP kit 34 includes a processor, a memory device, and a communication device. The processor executes various information processing by executing a computer program. The various information processing includes vehicle travel control processing. The memory device contains the various information. The communication device performs the Near Field Communication with the parking facility 20.

In the loading processing, a loading guidance information LGI is generated. The loading guidance information LGI contains traveling route data from the platform area to the parking space assigned to the vehicle 30. When the loading guidance information LGI is received from the parking facility 20, the AVP kit 34 performs the vehicle travel control processing based on the loading guidance information LGI. In the vehicle travel control, the vehicle 30 is operated such that the vehicle 30 travels along the traveling route. When the vehicle 30 arrives at the parking space, the AVP kit 34 stops the operating of the vehicle 30. The loading guidance information LGI may be changed sequentially in response to changes in a situation change within the parking facility 20. The changed loading guidance information LGI is transmitted to the AVP kit 34.

After the vehicle 30 is stopped, a loading completion information LCI is transmitted from the AVP kit 34 to the parking facility 20. In the loading processing, the parking information PKI in the memory device of the parking facility 20 is updated based on the loading completion information LCI. When the parking information PKI is updated, the updated parking information PKI is transmitted to the management server 10.

### 3-2. Flow of Loading Processing

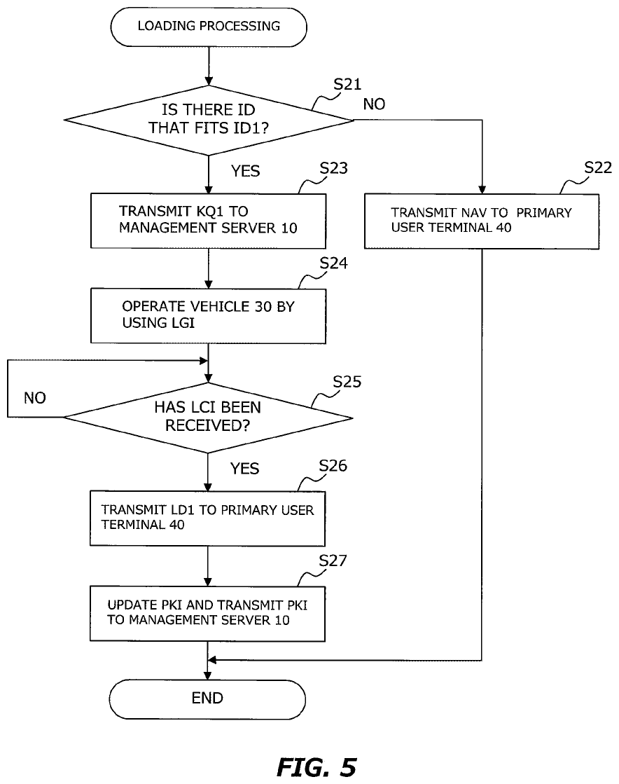

FIG. 5 is a flow chart showing a flow of the loading processing relating to the first embodiment. The routine shown in FIG. 5 is executed at a predetermined iteration cycle.

In the routine shown in FIG. 5, first, the parking facility 20 determines whether the identification ID that matches the one received from the primary user terminal 40 is stored in the memory device (step S21). If the parking request processing based on the parking request information PRQ1 is executed in the management server 10, the identification ID1 is transmitted from the management server 10 to the parking facility 20. Therefore, if the identification ID1 is not stored in the memory device, the determination result of the step S21 is negative. If the determination result of the step S21 is negative, the parking facility 20 transmits the unavailable information NAV to the primary user terminal 40 (step S22).

If the determination result of the step S21 is positive, the parking facility 20 transmits the key request KQ1 to the management server 10 (step S23). Then, upon receiving the operation authority key KY1 from the management server 10, the parking facility 20 operates the vehicle 30 using the loading guidance information LGI (step S24). The loading guidance information LGI is generated based on the parking information PKI. The condition for parking PKC1 may be considered in generating of the loading guidance information LGI. An actual operation of the vehicle 30 is performed by the AVP kit 34 that receives the loading guidance information LGI from the parking facility 20.

Subsequent to the step S24, the parking facility 20 determines whether the loading completion information LCI has been received (step S25). The loading completion information LCI is transmitted from the AVP kit 34 to the parking facility 20 when the vehicle 30 arrives at the parking space and the vehicle 30 is stopped. If the determination result of the step S25 is negative, the parking facility 20 executes the processing of the step S25 again.

If the determination result of the step S25 is positive, the parking facility 20 transmits the loading information LD1 to the primary user terminal 40 (step S26). The loading information LD1 is information on a loading status of the vehicle 30. According to the loading information LD1, the primary user can grasp the loading state. The parking facility 20 also updates the parking information PKI and transmits it to the management server 10 (step S27). The processing of the step S27 may be executed before the execution of the processing of the step S26.

### 3-3. Outline of Unloading Processing

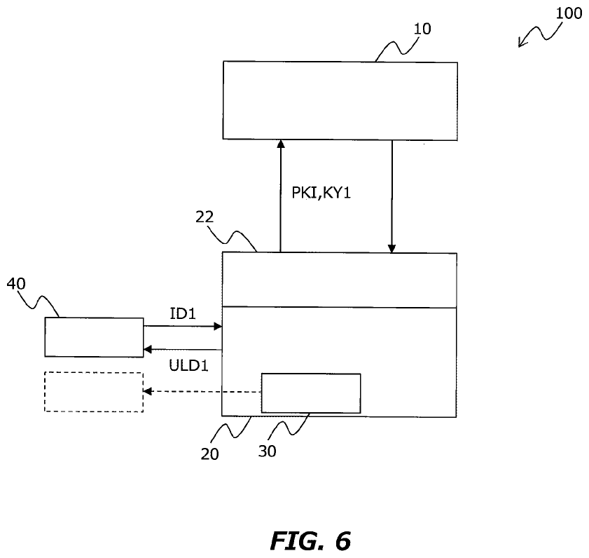

The parking facility 20 (the control center 22A or 22B) performs unloading processing of the vehicle. Contents of the unloading processing is essentially the same as those of the loading processing described in FIG. 4. Therefore, the description overlapping with the content of the loading processing is omitted as appropriate. FIG. 6 is a diagram for explaining an outline of the unloading processing according to the first embodiment. The unloading processing is initiated when the authentication device of the parking facility 20 receives the identification ID1 from the primary user terminal 40.

In the unloading processing, if the identification ID1 received from the primary user terminal 40 matches the identification ID1 stored in the memory device of the parking facility 20, communication is performed between the parking facility 20 and the AVP kit 34. In the unloading processing, an unloading guidance information ULGI is generated. The unloading guidance information ULGI contains information on a traveling route from the parking space of vehicle 30 to the platform area. When the unloading guidance information ULGI is received from the parking facility 20, the AVP kit 34 performs the vehicle travel control processing based on the unloading guidance information ULGI. When the vehicle 30 arrives at the platform area, the AVP kit 34 stops the operation of the vehicle 30. The unloading guidance information ULGI may be changed sequentially in response to a situation change within parking facility 20. The changed unloading guidance information ULGI is transmitted to the AVP kit 34.

After the operation of the vehicle 30 is stopped, the unloading completion information ULCI is transmitted from the AVP kit 34 to the parking facility 20. In the unloading processing, the operation authority key KY1 is returned from the parking facility 20 to the management server 10 after transmitting the unloading completion information ULCI. When the operation authority key KY1 is returned, the operation authority of the vehicle 30 moves from the parking facility 20 to the primary user. In the unloading processing, the parking information PKI stored in the memory device of the parking facility 20 is updated based on the unloading completion information ULCI. When the parking information PKI is updated, the updated parking information PKI is transmitted to the management server 10.

### 3-4. Flow of Unloading Processing

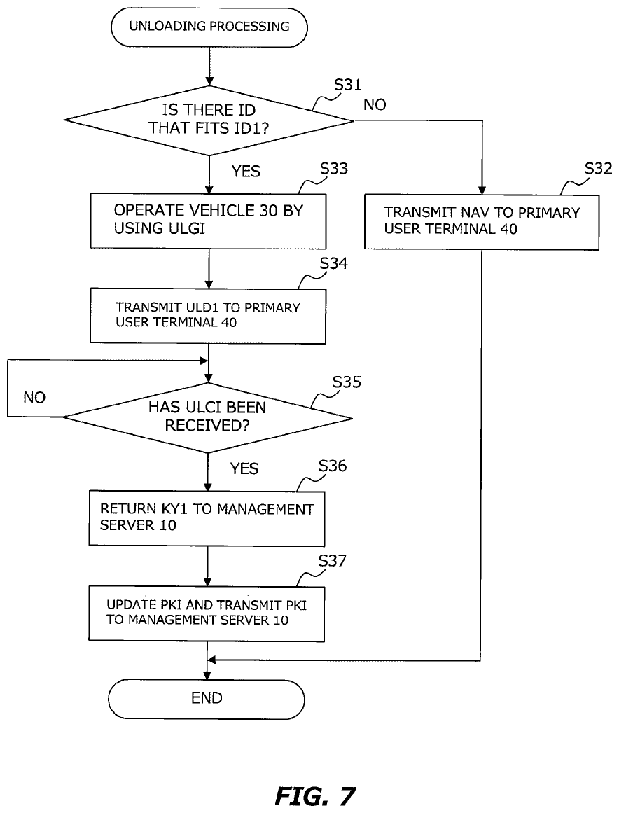

FIG. 7 is a flow chart showing the flow of unloading processing according to the first embodiment. The routine shown in FIG. 7 is executed at a predetermined iteration cycle.

In the routine shown in FIG. 7, first, the parking facility 20 performs the processing of the step S31. The content of the processing of the step S31 is the same as that of the step S21 shown in FIG. 5. If the determination result of the step S31 is negative, the parking facility 20 transmits the unavailable information NAV to the primary user terminal 40 (step S32).

If the determination result of the step S31 is positive, the parking facility 20 operates the vehicle 30 by using the unloading guidance information ULGI (step S33). The unloading guidance information ULGI is generated based on the parking information PKI. The actual operation of the vehicle 30 is performed by the AVP kit 34 that receives the unloading guidance information ULGI from the parking facility 20. During the operation of the vehicle 30, the parking facility 20 transmits unloading information ULD1 to the primary user terminal 40 (step S34). The unloading information ULD1 is information on an unloading status of the vehicle 30. According to the unloading information ULD1, the primary user can grasp the unloading state.

Subsequent to the step S34, the parking facility 20 determines whether the unloading completion information ULCI has been received (step S35). The unloading completion information ULCI is transmitted from the AVP kit 34 to the parking facility 20 when the vehicle 30 arrives at the platform area. If the determination result of the step S35 is negative, the parking facility 20 performs the processing of the step S35 again.

If the determination result of the step S35 is positive, the parking facility 20 returns the operation authority key KY1 to the management server 10 (step S36). When the operation authority key KY1 is returned from the parking facility 20, the operation authority of the vehicle 30 moves from the parking facility 20 to the primary user. This allows the primary user to manipulate the vehicle 30. The parking facility 20 also updates the parking information PKI and transmits it to the management server 10 (step S37). The processing of the step S37 may be performed before the processing of the step S36.

### 4. Lease Request Processing

### 4-1. Outline

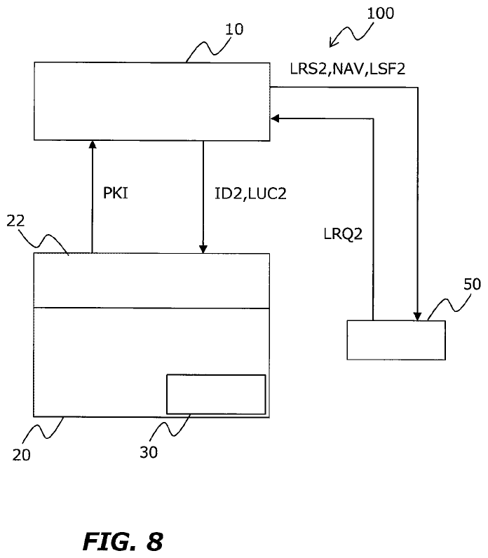

The management server 10 (the processor 12) executes the lease request processing. FIG. 8 is a diagram for explaining an outline of the lease request processing according to the first embodiment. The lease request processing is initiated when the management server 10 receives a lease request information LRQ2 from the secondary user terminal 50. The lease request information LRQ2 is stored in the management server 10 (the memory device 14). The lease request information LRQ2 includes an identification ID2 and a condition for lease-use LUC2.

The identification ID2 contains ID data of a secondary user who carries the secondary user terminal 50. The ID data of the secondary user is registered by the management server 10 (the memory device 14) at the initial use of the AVP service. The registered ID data of the secondary user is utilized for the authentication of a second and subsequent uses of the AVP service.

The condition for lease-use LUC2 is a condition for using the lease vehicle. The condition for lease-use LUC2 is set each time the AVP-service is used by the secondary user. The condition for lease-use LUC2 contains data indicating basic items of the lease and data indicating items that the secondary user wishes to the lease vehicle. Examples of the basic items include an area from which the lease starts (or current location of the secondary user), desired rental date, and desired rental timezone (start time and end time). Examples of the desired items include items corresponding to the desired items included in the condition for lease-offer LOC. Specifically, return of the lease vehicle without refueling or charge, use of space for baggage, and smoking in space for ride.

The management server 10 periodically receives the parking information PKI from the parking facility 20. In the lease request processing, the parking request information PRQ1 and the parking information PKI are referenced, and the vehicle 30 that matches the condition for lease-use LUC2 is selected as the lease vehicle. The vehicle 30 is selected based on whether or not the condition for lease-use LUC2 agrees on the condition for parking PKC1 and the condition for lease-offer LOC of the vehicle 30 using the AVP service. If the lease vehicle is selected, the identification ID2 and the condition for lease-use LUC2 are transmitted to the control center of the parking facility 20 in which the lease vehicle is parked.

In the lease request processing, when the lease vehicle is selected, a lease reserve information LRS2 is transmitted to the secondary user terminal 50. The lease reserve information LRS2 contains the lease vehicle, the parking facility 20 in which the vehicle is parked, scheduled rental date, and scheduled rental timezone (start-time and end-time). In the lease request processing, a lease fee information LSF2 may be transmitted to the secondary user terminal 50 along with the lease reserve information LRS2. The lease fee information LSF2 is an estimated lease fee LF based on the basic data.

### 4-2. Processing Flow

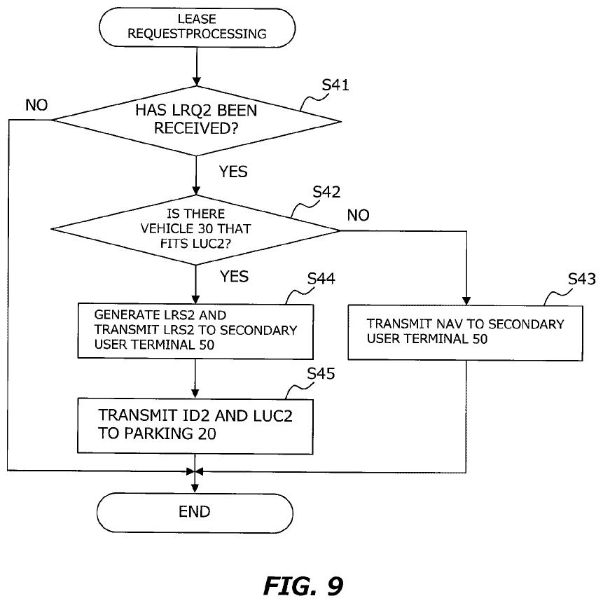

FIG. 9 is a flow chart showing a flow of the lease request processing according to the first embodiment. The routine shown in FIG. 9 is executed at a predetermined iteration cycle.

In the routine shown in FIG. 9, first, the management server 10 determines whether or not it has received the lease request information LRQ2 (step S41). If the secondary user wants to use the AVP service, the secondary user launches the application software for the AVP and enters the lease request information LRQ2. This causes the lease request information LRQ2 to be transmitted from the secondary user terminal 50 to the management server 10. If the determination result of the step S41 is negative, the management server 10 ends the processing of this routine.

If the determination result of the step S41 is positive, the management server 10 determines whether or not there is the vehicle 30 that matches the condition for lease-use LUC2 (step S42). In the processing of the step S42, data relating to the condition on a lease-providing party is referenced, and the vehicle 30 that matches the condition for lease-use LUC2 is searched. If the determination result of the step S42 is negative, the management server 10 transmits the unavailable information NAV to the secondary user terminal 50 (step S43).

If the determination result of the step S42 is positive, the management server 10 transmits the lease reserve information LRS2 to the secondary user terminal 50 (step S44). The management server 10 also transmits the identification ID2 and the condition for lease-use LUC2 to the parking facility 20 in which the vehicle 30 being selected as the lease vehicle is parked (step S45).

### 5. Lease Conducting Processing

The management server 10 and the parking facility 20 (the control center 22A or 22B) execute the lease conducting processing of the vehicle 30 selected as the lease vehicle. The lease conducting processing includes lease vehicle lending and returning processing that is executed by the parking facility 20. The lease conducting processing contains lease notice processing that is executed by the management server 10.

### 5-1. Outline of Lending Processing

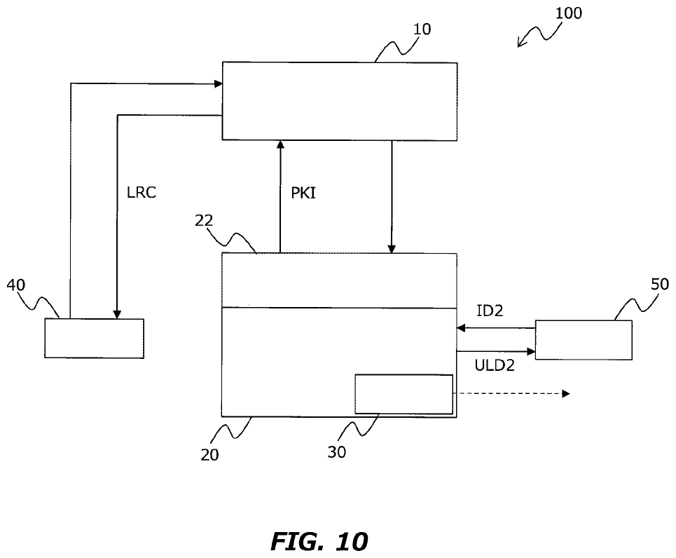

The content of the lending processing is essentially the same as that of the loading processing described in FIG. 4 or that of the unloading processing described in FIG. 6. Therefore, the description overlapping with the content of the processing is omitted as appropriate. FIG. 10 is a diagram for explaining an outline of the lending processing according to the first embodiment. The lending processing is initiated when the authentication device of the parking facility 20 receives the identification ID2 from the secondary user terminal 50. The identification ID2 is transmitted from the management server 10 to the parking facility 20 when the lease request processing based on the lease request information LRQ2 is executed in the management server 10. In the lending processing, the identification ID2 received from the secondary user terminal 50 is matched with the identification ID2 transmitted to the parking facility 20 via the management server 10.

In the lending processing, if the identifications ID2 are matched with each other, communication is performed between the parking facility 20 and the AVP kit 34. In the lending processing, the unloading guidance information ULGI is generated. When receiving the unloading guidance information ULGI from the parking facility 20, the AVP kit 34 executes the vehicle travel control processing based on the unloading guidance information ULGI. When the vehicle 30 arrives at the platform area, the AVP kit 34 stops the operation of the vehicle 30.

After the operation of the vehicle 30 is stopped, the unloading completion information ULCI is transmitted from the AVP kit 34 to the parking facility 20. In the lending processing, the operation authority key KY1 is returned from the parking facility 20 to the management server 10 after transmitting the unloading completion information ULCI. In the lending processing, also, the parking information PKI stored in the memory device of the parking facility 20 is updated based on the unloading completion information ULCI. When the parking information PKI is updated, the updated parking information PKI is transmitted to the management server 10.

### 5-2. Flow of Lending Processing

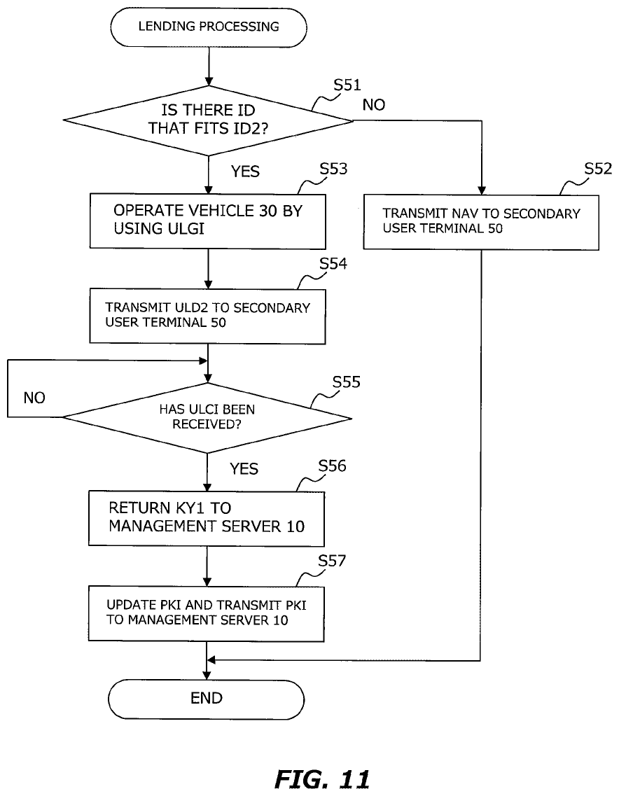

FIG. 11 is a flow chart showing a flow of the lending processing according to the first embodiment. The routine shown in FIG. 11 is executed at a predetermined iteration cycle.

In the routine shown in FIG. 11, first, the parking facility 20 determines whether the identification ID that matches the one received from the secondary user terminal 50 is stored in the memory device (Step S51). If the determination result of the step S51 is negative, the parking facility 20 transmits the unavailable information NAV to the secondary user terminal 50 (step S52).

If the determination result of the step S51 is positive, the parking facility 20 executes the processing of the step S53. The content of the processing of the step S53 is the same as that of the step S33 in FIG. 7. During the operation of the vehicle 30, the parking facility 20 transmits unloading information ULD2 to the secondary user terminal 50 (step S54). The unloading information ULD2 is information on an unloading status of the vehicle 30. According to the unloading information ULD2, the secondary user can grasp the unloading state.

Subsequent to the step S54, the parking facility 20 executes the processing of the steps S55 to S57. The content of the processing of the step S55 is the same as that of the step S35 in FIG. 7. The content of the process of step S56 is the same as that of the step S36 in FIG. 7. When the processing of the step S56 is executed, the operation authority of the vehicle 30 is moved from the parking facility 20 to the secondary user. This allows the secondary user to manipulate the vehicle 30. The content of the processing of the step S57 is the same as that of the step S37 in FIG. 7.

### 5-3. Outline of Returning Processing

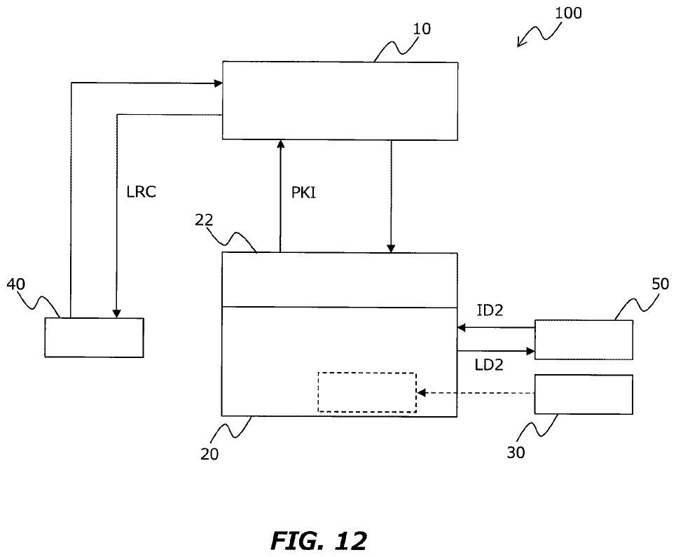

The content of the returning processing is essentially the same as that of the loading processing described in FIG. 4 or that of the lending processing described in FIG. 10. Therefore, the description overlapping with the content of the processing is omitted as appropriate. FIG. 12 is a diagram for explaining an outline of the returning processing according to the first embodiment. The returning processing is initiated when the authentication device of the parking facility 20 receives the identification ID2 from the secondary user terminal 50.

In the returning processing, if the identification ID2 received from the secondary user terminal 50 matches the identification ID2 stored in the memory device of the parking facility 20, communication is performed between the parking facility 20 and the AVP kit 34. In the returning processing, the loading guidance information LGI is generated. When receiving the loading guidance information LGI from the parking facility 20, the AVP kit 34 executes vehicle travel control processing based on the loading guidance information LGI. When the vehicle 30 arrives at the parking space, the AVP kit 34 stops the operating of the vehicle 30.

After the vehicle 30 is stopped, the loading completion information LCI is transmitted from the AVP kit 34 to the parking facility 20. In the returning processing, the parking information PKI in the memory device of the parking facility 20 is updated based on the loading completion information LCI. When the parking information PKI is updated, the updated parking information PKI is transmitted to the management server 10.

### 5-4. Flow of Returning Processing

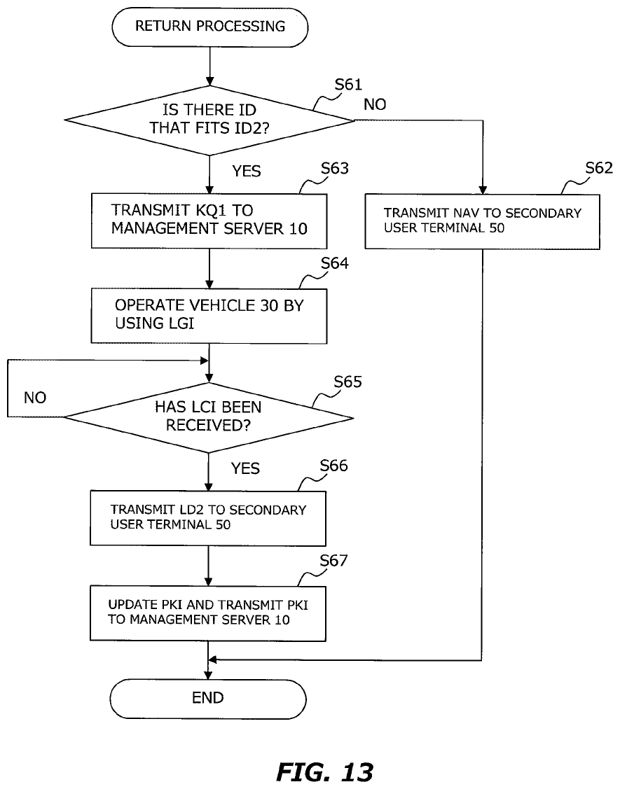

FIG. 13 is a flow chart showing a flow of the returning processing according to the first embodiment. The routine shown in FIG. 13 is executed at a predetermined iteration cycle.

In the routine shown in FIG. 13, first, the parking facility 20 executes the processing of the step S61. The content of the processing of the step S61 is the same as that of the step S51 in FIG. 11. If the determination result of the step S61 is negative, the parking facility 20 transmits the unavailable information NAV to the secondary user terminal 50 (step S62).

If the determination result of the step S61 is positive, the parking facility 20 executes the processing of the steps S63 to S65. The content of the processing of the step S63 is the same as that of the step S23 in FIG. 5. The content of the processing of the step S64 is the same as that of the step S24 in FIG. 5. The content of the processing of the step S65 is the same as that of the step S25 in FIG. 5.

If the determination result of the step S65 is positive, the parking facility 20 transmits the loading information LD2 to the secondary user terminal 50 (step S66). The loading information LD2 is information on the loading status of the vehicle 30. According to the loading information LD2, the secondary user can grasp the loading state. The parking facility 20 also executes the processing of the step S67. The content of the processing of the step S67 is the same as that of the step S27 in FIG. 5.

### 5-5. Lease Notice Processing

The management server 10 executes the lease notice processing. In the lease notice processing, a lease history information LRC is notified to the primary user of the vehicle 30 selected as the lease vehicle. The Lease history information LRC is information on an implementation status of the lease of the vehicle 30. The Lease history information LRC is transmitted from the management server 10 to the primary user terminal 40 of the primary user. The timing at which the lease history information LRC is transmitted may be the timing at which the leasing of the vehicle 30 is started or the timing at which the lease of the vehicle 30 is finished. According to the lease history information LRC, the primary user can grasp the status of the implementation status of the lease.

### 6. Parking Fee Checkout Processing

The management server 10 (the processor 12) executes the parking fee checkout processing. In the parking fee checkout processing, the parking fee PF of the primary user is settled. If the lease of the vehicle 30 is performed, the vehicle 30 is not present in the parking facility 20 during the lease. In addition, if the lease of the vehicle 30 is performed, lease fee occurs. In the parking fee checkout processing, the parking fee PF is calculated in consideration of these discount factors.

### 6-1. First Example

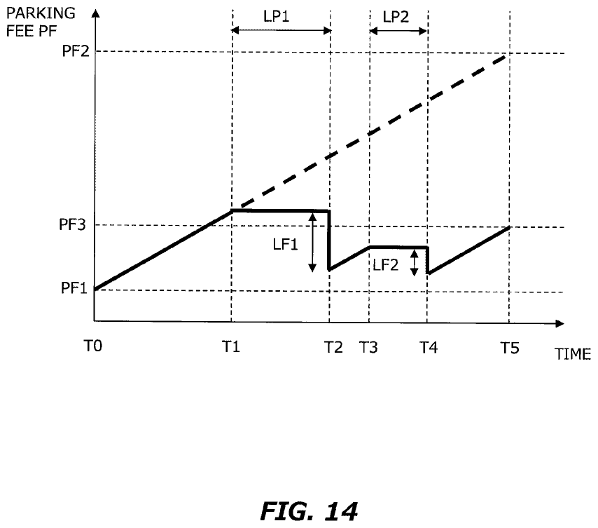

FIG. 14 is a diagram for explaining a first example of the parking fee checkout processing according to the first embodiment. The first example assumes a charge system in which the parking fee PF is charged according to a parking time. The fee PF1 is a standard usage fee of the AVP-services. That is, when the AVP service is used, the AVP service generates at least the fee PF1.

In the example shown in FIG. 14, the loading of the vehicle 30 based on the parking request information PRQ1 is completed at time TO and the unloading of the vehicle 30 based on the parking request information PRQ1 is completed at time T5. When the vehicle 30 is parked from time T0 to time T5, the parking fee PF rises to a fee PF2. However, during a period LP1 from time T1 to time T2 and a period LP2 from time T3 to time T4, the vehicle 30 is used as the lease vehicle. Then, no parking fee is charged between lease periods LP1 and LP2. In addition, lease fee LF1 is generated during the lease period LP1, and lease fee LF2 is generated during the lease period LP2. Therefore, in the first example, the parking fee PF occurs from the time T0 to T1, from the time T2 to T3, and from the time T4 to T5. Further, the parking fee PF is discounted by an amount of the lease fees LF1 and LF2. As a result, the parking fee PF at the time T5 when the vehicle 30 is unloaded is suppressed to a fee PF3 (<the PF2).

### 6-2. Second Example

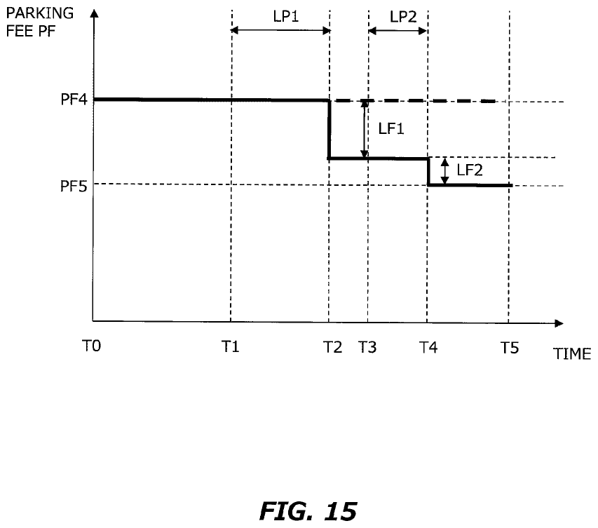

FIG. 15 is a diagram for explaining a second example of the parking fee checkout processing according to the first embodiment. The second example assumes a charge system in which a fixed parking fee PF is charged regardless of the parking time. A fee PF4 includes a standard usage fee of the AVP service (i.e., the fee PF1).

The time T0 to time T5 shown in FIG. 15 are the same as that shown in FIG. 14. When the vehicle 30 is parked from the time T0 to time T5, the parking fee PF does not change at the fee PF4. However, during the periods LP1 and LP2, if the vehicle 30 is used as the lease vehicle, then the lease fees LF1 and LF2 will occur. Therefore, in the second example, the parking fee PF is discounted by the lease fees LF1 and LF2. As a result, the parking fee PF at the time T5 when the vehicle 30 is unloaded is suppressed to price a fee PF5 (<the PF4).

### 7. Lease Fee Checkout Processing

The management server 10 (the processor 12) executes the lease fee checkout processing. In the lease fee checkout processing, the lease fee LF of the secondary user is settled. In the lease fee checkout processing, the lease fee LF is charged according to a real-time use usage of the lease vehicle, or the fixed lease fee LF is charged regardless of the real-time usage.

### 8. Effect

According to the AVP system of the first embodiment, the parking request processing is executed. In the parking request processing, if the parking facility 20 is selected, the parking reservation information PRS1 is transmitted to the primary user terminal 40. Further, when the condition for lease-offer LOC is set, this condition for lease-offer LOC is transmitted to the secondary user terminal 50. Therefore, it is possible to urge the secondary user to use the lease of the vehicle 30. If the secondary user utilizes the AVP service, the space for AVP occupied by the vehicle 30 will be empty. Therefore, it is possible to solve the occupation of the space for AVP for a long time. In addition, it is possible to increase a rotational rate of the space for AVP.

According to the AVP system of the first embodiment, the lease request processing is executed. In the lease request processing, the lease vehicle is selected based on whether or not the condition for lease-use LUC2 agree on the condition for parking PKC1 of the vehicle 30 using the AVP service and the condition for lease-offer LOC. This allows the primary user who leases the vehicle 30 and the secondary user who utilizes the lease vehicle to be matched effectively.

According to the AVP system of the first embodiment, the parking fee checkout processing is executed. In the parking fee checkout processing, the parking fee PF is calculated in consideration of the discount factors. Therefore, it is possible for the primary user to obtain a merit in the parking fee when the vehicle 30 is leased during the loading to the parking facility 20 based on the parking request information PRQ1.

### Second Embodiment

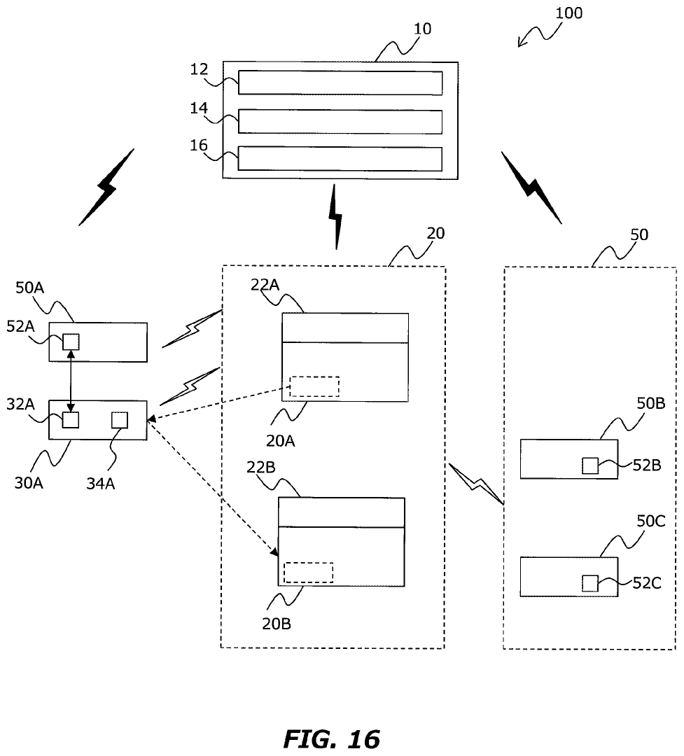

A second embodiment of the present disclosure will be described with reference to FIG. 16 to FIG. 21. Note that the description overlapping with the first embodiment is omitted as appropriate.

### 1. Assumption

FIG. 16 is a diagram illustrating an assumption of the second embodiment. In the second embodiment, the secondary user uses the AVP service, and the vehicle 30A is lent out as the lease vehicle. The secondary user terminal 50A is a terminal carried by a secondary user who borrows the vehicle 30A. The communication device 52A performs wireless communication with the management server 10 via the network. The communication device 52A also performs the authentication with the authentication device of the parking facility 20 (i.e., the parking facilities 20A and 20B) by the Near Field Communication or the proximity wireless communication. The communication device 52A further performs the authentication with the vehicle 30A by the Near Field Communication or the proximity wireless communication.

The vehicle 30A is unloaded from the parking facility 20A. In the first embodiment described above, the lending and returning of the vehicle 30 as the lease vehicle was carried out in a single parking facility 20. On the other hand, in the second embodiment, the vehicle 30A as the lease vehicle is parked to the parking facility 20B instead of parking to the parking facility 20A. The operation of the vehicle 30A from the parking facility 20A to the parking facility 20B is performed by the secondary user. The operation of the vehicle 30 from the parking facility 20B to the parking facility 20A are also performed by the secondary user.

### 2. Parking Request Processing (Incidental Parking Request Processing)

### 2-1. Outline

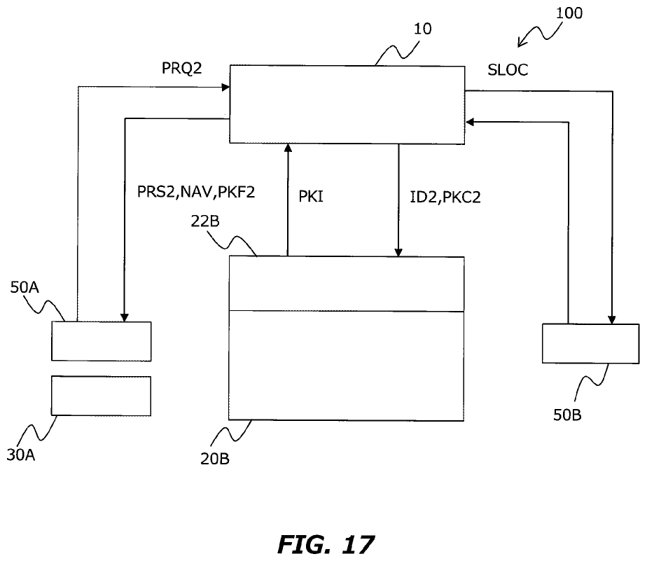

The management server 10 (the processor 12) executes the parking request processing. In order to distinguish the parking request processing in the second embodiment from that in the first embodiment, the one related to second embodiment is hereinafter referenced as “incidental parking request processing”. FIG. 17 is a diagram for explaining an outline of the incidental parking request processing. The incidental parking request processing is initiated when management server 10 receives the parking request information PRQ2 from the secondary user terminal 50A. The parking request information PRQ2 is stored in the management server 10 (the memory device 14). The parking request information PRQ2 includes the identification ID2, a condition for parking PKC2 and a condition for sublease-offer SLOC.

The condition for parking PKC2 is basically the same as the condition for parking PKC1 described in FIG. 2. In the explanation of the condition for parking PKC1, replace the “primary user” with the “secondary user”. This explains the condition for parking PKC2.

The condition for sublease-offer SLOC is essentially the same as the condition for lease-offer LOC described in FIG. 2. In the explanation of the condition for lease-offer LOC, replace the “secondary user” with the “incidental secondary user” and replace the “primary user” with the “secondary user”. This explains the condition for sublease-offer SLOC.

In the incidental parking request processing, the parking information PKI is referenced and the parking facility 20 (i.e., the parking facility 20B) is selected that matches the condition for parking PKC2. In the incidental parking request processing, the parking space to be assigned to the vehicle 30A may be determined when the parking facility 20 is selected.

In the incidental parking request processing, if the parking facility 20 is selected, the identification ID2 and the condition for parking PKC2 are transmitted to the control center (i.e., the control center 22B) of this parking facility 20. In the incidental parking request processing, if the condition for sublease-offer SLOC is set, this condition for sublease-offer SLOC is transmitted to the secondary user terminals 50B and 50C.

A timing at which the condition for sublease-offer SLOC is transmitted may be the timing at which the parking facility 20 is selected, or may be the timing later than that. For example, when the management server 10 receives the lease request information LRQ from the secondary user terminal 50B or 50C, the condition for sublease-offer SLOC may be transmitted to the secondary user terminal 50B or 50C.

In the incidental parking request processing, the parking reservation information PRS2 is also transmitted to the secondary user terminal 50A if the parking facility 20 is selected. The parking reservation information PRS2 contains the selected parking facility 20 (i.e., the parking facility 20B), the scheduled rental date, and the scheduled rental timezone. In the incidental parking request processing, the parking fee informational PKF2 may be transmitted to the secondary user terminal 50A along with the parking reservation information PRS2. The parking fee data PKF2 is an estimated amount of the parking fee PF calculated based on the condition for parking PKC2. If the condition for sublease-offer SLOC is set, the acknowledgement may be transmitted to the secondary user terminal 50A along with the parking reservation information PRS2.

### 2-2. Processing Flow

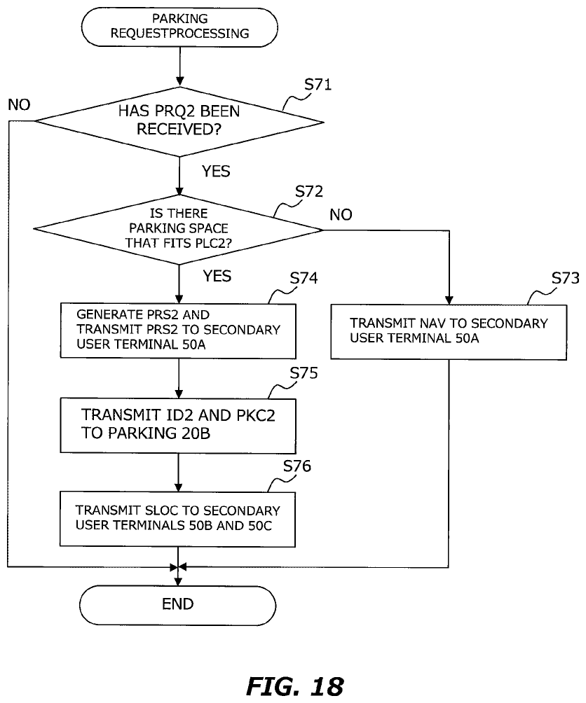

FIG. 18 is a flow chart showing a flow of the parking request processing according to the second embodiment. The routine shown in FIG. 18 is executed at a predetermined iteration cycle.

The processing from step S71 to step S76 shown in FIG. 18 is basically the same as that from the step S11 to step S16 described in FIG. 3. In the description of the step S11, the “PRQ1” is replaced with the “PRQ2”, and in the description of the step S12, the “PKC1” is replaced with the “PKC2”. Further, in the explanation of the step S13, the “secondary user terminal 50” is replaced with the “secondary user terminal 50A”. Then, the processing from the step S71 to the step S73 will be described.

In the explanation of the step S14, the “PRS1” is replaced with the “PRS2” and the “secondary user terminal 50” is replaced with the “secondary user terminal 50A”. Further, in the explanation of the step S15, the “parking facility 20” is replaced with the “parking facility 20B”, the “ID1” is replaced with the “ID2”, and the “PKC1” is replaced with the “PKC2”. Further, in the description of the step S16, the “secondary user terminal 50” is replaced with the “secondary user terminals 50B and 50C”, the “LOC” is replaced with the “SLOC”. Then, the processing from the step S74 to the step S76 will be described.

### 3. Loading and Unloading Processing

### 3-1. Loading Processing (Incidental Loading Processing)

The parking facility 20B (the control center 22B) executes loading processing of the vehicle 30A. In order to distinguish the loading processing in the second embodiment from that in the first embodiment, the one related to the second embodiment is hereinafter referenced as “incidental loading processing”. The incidental loading processing will be described by appropriately replacing the description with respect to FIG. 4. Specifically, the “parking facility 20” in the explanation with respect to FIG. 4 is replaced with the “parking facility 20B”, the “primary user terminal 40” is replaced with the “secondary user terminal 50A”, and the “ID1” is replaced with the “ID2”. In addition, the “KQ1” is replaced with the “KQ2”, the “vehicle 30” is replaced with the “vehicle 30A”, and the “AVP kit 34” is replaced with the “AVP kit 34A”. Then, the incidental loading processing will be described.

The explanation of a flow of the incidental loading processing is explained by appropriately replacing that with respect to FIG. 5. Specifically, in the explanation with respect to FIG. 5, the “ID1” is replaced with the “ID2” and the “KQ1” is replaced with the “KQ2”. In addition, the “vehicle 30” is replaced with the “vehicle 30A”, the “PKC1” is replaced with the “PKC2”, and the “AVP kit 34” is replaced with the “AVP kit 34A”. Furthermore, the “primary user terminal 40” is replaced with the “secondary user terminal 50A” and the “LD1” is replaced with the “LD2”. This explains the incidental loading processing flow.

### 3-2. Unloading Processing (Incidental Unloading Processing)

The parking facility 20B (the control center 22B) executes unloading processing of the vehicle 30A. In order to distinguish the unloading processing in the second embodiment from that in the first embodiment, the one related to the second embodiment is hereinafter referenced as “incidental unloading processing”. The incidental unloading processing will be described by appropriately replacing the description with respect to FIG. 6. Specifically, in the explanation with respect to FIG. 6, the “parking facility 20” is replaced with the “parking facility 20B”, the “primary user terminal 40” is replaced with the “secondary user terminal 50A”, and the “ID1” is replaced with the “ID2”. In addition, the “vehicle 30” is replaced with the “vehicle 30A” and the “AVP kit 34” is replaced with the “AVP kit 34A”. This explains the incidental unloading processing.

The explanation of a flow of the incidental unloading processing is explained by appropriately replacing the explanation with respect to FIG. 7. Specifically, in the explanation with respect to FIG. 7, the “parking facility 20” is replaced with the “parking facility 20B” and the “vehicle 30” is replaced with the “vehicle 30A”. In addition, the “primary user terminal 40” is replaced with the “secondary user terminal 50A” and the “ULD1” is replaced with the “ULD2”. This explains the incidental unloading processing flow.

### 4. Lease Request Processing (Incidental Lease Request Processing)

### 4-1. Outline

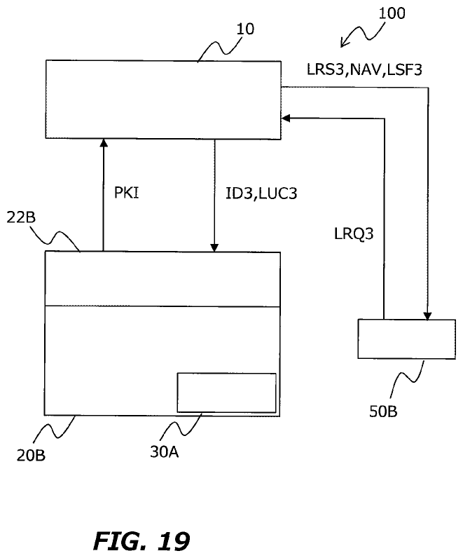

The management server 10 (the processor 12) executes lease request processing. In order to distinguish the lease request processing in the second embodiment from that in the first embodiment, the one related to the second embodiment is hereinafter referenced as “incidental lease request processing”. FIG. 19 is a diagram for explaining an outline of the incidental lease request processing. The incidental lease request processing is initiated when the management server 10 receives a lease request information LRQ3 from the secondary user terminal 50B (or 50C). The lease request information LRQ3 is stored in the management server 10 (the memory device 14). The lease request information LRQ3 includes an identification ID3 and a condition for lease-use LUC3.

The identification ID3 contains the ID data of the secondary user who carries the secondary user terminal 50B. The identification ID3 is described by referring to the identification ID2 described with respect to FIG. 8. The condition for lease-use LUC3 is a condition for using lease vehicle. The condition for lease-use LUC3 will be described by reference to the description of the condition for lease-use LUC2 given in FIG. 8.

In the incidental lease request processing, the parking request information PRQ2 and the parking information PKI are referenced, and the vehicle 30 (i.e., the vehicle 30A) that matches the condition for lease-use LUC3 is selected as the lease vehicle. The vehicle 30 is selected based on whether or not the condition for lease-use LUC3 matches the condition for parking PKC2 of the vehicle 30 using the AVP service and the condition for sublease-offer SLOC. If the lease vehicle is selected, the identification ID3 and the condition for lease-use LUC3 are transmitted to the control center (i.e., the control center 22B) of the parking facility 20 in which this lease vehicle is parked.

In the incidental lease request processing, when the lease vehicle is selected, the lease reserve information LRS3 is transmitted to the secondary user terminal 50B. The lease reserve information LRS3 contains the lease vehicle, the parking facility 20 in which the lease vehicle is parked (i.e., the parking facility 20B), scheduled rental date, and scheduled rental timezone. In the incidental lease request processing, a lease fee information LSF3 may be transmitted to the secondary user terminal 50B along with the lease reserve information LRS3. The lease fee information LSF3 is an estimated amount of lease fee LF.

### 4-2. Processing Flow

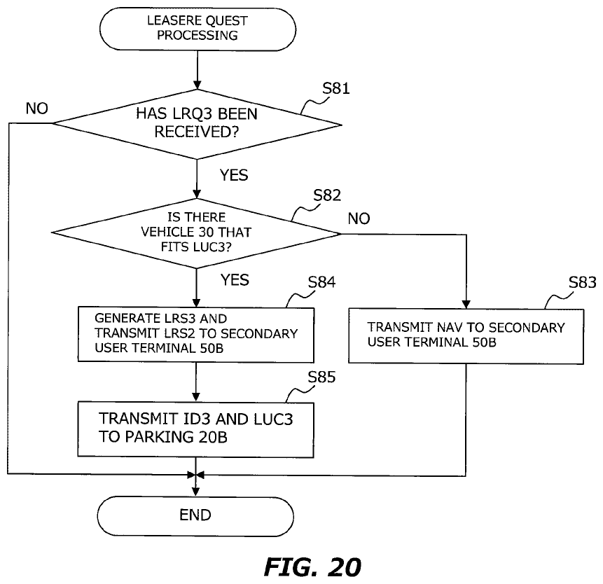

FIG. 20 is a flow chart showing a flow of the incidental lease request processing. The routine shown in FIG. 20 is executed at a predetermined iteration cycle.

The processing from step S81 to step S85 shown in FIG. 20 is basically the same as that from the step S41 to the step S45 described in FIG. 9. In the description of step S41, the “LRQ2” is replaced with the “LRQ3”, and in the description of step S42, the “LUC2” is replaced with the “LUC3”. Thus, the processing from step S81 to step S82 will be described. In the second embodiment, it is assumed that vehicle 30A is subleased. However, in the processing of the step S82, the vehicle 30 being different from the vehicle 30A (e.g., the vehicle 30B parked in the parking facility 20B) may be selected as the lease vehicle

In the explanation of the step S43, the “secondary user terminal 50” is replaced with the “secondary user terminal 50B”. In the explanation of step S44, the “LRS2” is replaced with the “LRS3” and the “secondary user terminal 50” is replaced with the “secondary user terminal 50B”. In the explanation of the step S45, the “parking facility 20” is replaced with the “parking facility 20B”, the “ID2” is replaced with the “ID3”, and the “LUC2” is replaced with the “LUC3”. Then, the processing from step S83 to step S85 will be described.

### 5. Sublease Conducting Processing

The management server 10 and the parking facility 20B (the control center 22B) execute sublease conducting processing of the vehicle 30A. The sublease conducting processing includes lending and returning processing of the vehicle 30A that is executed by the parking facility 20B. In order to distinguish the lending and returning processing in the second embodiment from that in the first embodiment, lending processing in the second embodiment is hereinafter referenced as “incidental lending processing” and returning processing in the second embodiment is referenced as “incidental returning processing”. The sublease conducting processing contains lease notice processing that is executed by the management server 10. In order to distinguish the lease notice processing in the second embodiment from that in the first embodiment, the one in the second embodiment is hereinafter referenced as “different lease notice processing”.

### 5-1. Lending Processing (Incidental Lending Processing)

The incidental lending processing will be described by appropriately replacing the description with respect to FIG. 10. Specifically, in the description with respect to FIG. 10, the “parking facility 20” is replaced with the “parking facility 20B”, the “ID2” is replaced with the “ID3”, the “secondary user terminal 50” is replaced with the “secondary user terminal 50B”, and the “LRQ2” is replaced with the “LRQ3”. In addition, the “vehicle 30” is replaced with the “vehicle 30A” and the “AVP kit 34” is replaced with the “AVP kit 34A”. This explains the incidental lending processing.

The explanation of the flow of the incidental lending processing is explained by appropriately replacing the explanation with respect to FIG. 11. Specifically, in the explanation with respect to FIG. 11, the “ID2” is replaced with the “ID3”, the “parking facility 20” is replaced with the “parking facility 20B”, and the “ULD2” is replaced with the “ULD3”. This explains the incidental lending processing flow.

### 5-2. Returning Processing (Incidental Returning Processing)

The incidental returning processing will be described by appropriately replacing the description with respect to FIG. 12. Specifically, in the description with respect to FIG. 12, the “parking facility 20” is replaced with the “parking facility 20B”, the “ID2” is replaced with the “ID3”, and the “secondary user terminal 50” is replaced with the “secondary user terminal 50B”. In addition, the “vehicle 30” is replaced with the “vehicle 30A” and the “AVP kit 34” is replaced with the “AVP kit 34A”. This explains the incidental returning processing.

The explanation of the flow of incidental returning processing is explained by appropriately replacing the explanation with respect to FIG. 13. Specifically, in the explanation with respect to FIG. 13, the “ID2” is replaced with the “ID3”, the “parking facility 20” is replaced with the “parking facility 20B”, and the “LD2” is replaced with the “LD3”. This explains incidental returning processing flow.

### 5-3. Lease Notice Processing (Incidental Lease Notice Processing)

In the incidental lease notice processing, the secondary user who was parked the loading vehicle 30A to the parking facility 20B is notified of the lease history information LRC. The lease history information LRC is information on an implementation status of the sub-lease of vehicle 30A. The lease history information LRC is transmitted from the management server 10 to the secondary user terminal 50A. The timing at which the lease history information LRC is transmitted may be a timing at which the sub-lease of the vehicle 30A is started or a timing at which the sub-lease of the vehicle 30A is finished. According to the lease history information LRC, the secondary user who parked the vehicle 30A to the parking facility 20B can grasp the implementation status of the sub-lease.

### 6. Parking Fee Checkout Processing (Incidental Parking Fee Checkout Processing)

The management server 10 (the processor 12) executes parking fee checkout processing. In the parking fee checkout processing, the parking fee PF of the parking facility 20B is settled. In order to distinguish the parking fee checkout processing in the second embodiment from that in the first embodiment, the one related to the second embodiment is hereinafter referenced as “incidental parking fee checkout processing”. The incidental parking fee checkout processing will be explained by appropriately replacing the description with respect to FIG. 15.

Specifically, in the description of FIG. 14 and FIG. 15, the “vehicle 30” is replaced with the “vehicle 30A” and the “parking facility 20” is replaced with the “parking facility 20B”. In addition, the “parking request information PRQ1” is replaced with the “parking request information PRQ2”. In addition, the “lease vehicle” is replaced with the “sublease vehicle”, the “lease fee” is replaced with the “sublease fee” and the “lease period” is replaced with the “sublease period”. This explains the incidental parking fee checkout processing.

### 7. Lease Fee Checkout Processing (Incidental Lease Fee Checkout Processing)

The management server 10 (the processor 12) executes lease fee checkout processing. In order to distinguish the lease fee checkout processing in the second embodiment from that in the first embodiment, the one related to the second embodiment is hereinafter referenced as “incidental lease fee checkout processing”.

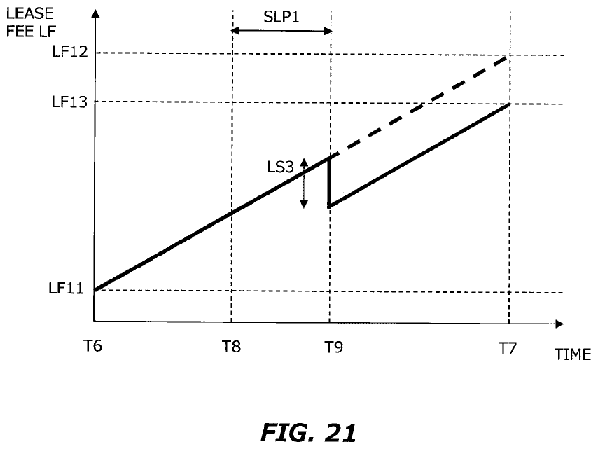

FIG. 21 is a diagram illustrating an example of the lease fee checkout processing. An example shown in FIG. 21 assumes a charge system in which the lease fee LF is charged according to the real-time usage. A lease fee LF11 is a standard usage fee of a lease service. That is, when the lease service is used, at least the fee LF11 is generated.

In the example shown in FIG. 14, the vehicle 30A is used as the lease vehicle from time T6 to time T7. In addition, the vehicle 30A is used as the sublease vehicle during a duration SLP1 from time T8 to time T9. As a result, an increase in the lease fee LF is suppressed by an amount corresponding to a lease fee LF3 during the sublease period SLP1. That is, the lease fee LF is discounted by the lease fee LF3. As a result, the lease fee LF that is generated in the return of the vehicle 30A to the parking facility 20A at the time T7 is suppressed to the fee LF13 (<the LF12).

### 8. Effect

According to the AVP system in the second embodiment, the incidental parking request processing is executed and the incidental lease request processing is executed. Therefore, the same effect as that in the AVP system in the first embodiment can be obtained. Further, according to the AVP system in the second embodiment, the incidental lease fee checkout processing is executed. Therefore, during the parking to the parking facility 20B based on the parking request information PRQ2, it is possible for the secondary user to obtain the merit of the lease fee when the vehicle 30A is subleased.

What is claimed is:

1. An automated valet parking system which is configured to manage an automated valet parking of a vehicle, comprising:
a processing device which is configured to execute travel control processing in a parking facility of the vehicle;
a primary user terminal which is a terminal of a primary user of the vehicle;
a secondary user terminal which is a terminal of a secondary user using a lease vehicle; and
a communication device which is configured to perform a communication between the primary user terminal and the processing device, and to perform the communication between the secondary user terminal and the processing device,
wherein the processing device is further configured to, when receiving from the primary user a parking request information, execute parking request processing to process the parking request information,
wherein the parking request information includes a condition for parking of the vehicle and a condition for lease-offer indicating a condition to provide a lease of the vehicle,
wherein, in the parking request processing, the processing device is configured to:
determine whether or not the parking facility has a parking space that satisfies the condition for parking; and
if it is determined that the parking facility has the parking space, transmit a parking reservation information to the primary user terminal and transmit the condition for lease-offer to the secondary user terminal.

2. The system according to claim 1,
wherein the processing device is further configured to, when receiving from the secondary user terminal a lease request information that includes a condition for lease-use indicating a condition to utilize the lease vehicle, execute lease request processing to process the lease request information,
wherein, in the lease request processing, the processing device is configured to:
determine whether or not the condition for parking and the condition for lease-offer agree on the condition for lease-use; and
if it is determined that the condition for parking and the condition for lease-offer agree on the condition for lease-use, transmit a lease reserve information to the secondary user terminal.

3. The system according to claim 1,
wherein the processing device is further configured to parking fee checkout processing to settle a parking fee of the primary user,
wherein, in the parking fee checkout processing, the processing device is configured to discount from the parking fee an amount in accordance with a lease fee of the vehicle, if the vehicle is provided to the lease during loading of the vehicle to the parking facility based on the parking request information.

4. The system according to claim 1, wherein:
the parking facility includes a first and a second parking facilities;
the secondary user terminal includes a first and a second user terminals; and
the processing device is further configured to execute, when receiving from the first user terminal incidental parking request information while the vehicle has been unloaded from the first parking and being leased, incidental parking request processing to process the incidental parking request information,
wherein the incidental parking request information includes incidental condition for parking of the vehicle and a condition for sublease-offer indicating a condition to provide a sublease of the vehicle,
wherein, in the incidental parking request processing, the processing device is configured to:
determine whether or not the second parking has incidental parking space that satisfies the incidental condition for parking; and
if it is determined that the second parking has the incidental parking space, transmit a parking reservation information to the first user terminal and transmit the condition for sublease-offer to the second user terminal.

5. The system according to claim 4,
wherein the processing device is further configured to, when receiving from the second user terminal incidental lease request information including incidental condition for lease-use indicating a condition to utilize the lease vehicle, execute incidental lease request processing to process the incidental lease request information,
wherein, in the incidental lease request processing, the processing device is further configured to:
determine whether or not the incidental condition for parking and the condition for sublease-offer agree on the incidental condition for lease-use; and
if it is determined that the incidental condition for parking and the condition for sublease-offer agree on the incidental condition for lease-use, transmit incidental lease reserve information to the second user terminal.

6. The system according to claim 4,
wherein the processing device is further configured to lease fee checkout processing to settle lease fee of the secondary user,
wherein, in the lease fee checkout processing, the processing device is configured to discount from the lease fee an amount in accordance with a sublease fee of the vehicle, if the vehicle is provided to the sublease during the loading of the vehicle to the second parking based on the incidental parking request information.
